(19) United States
(12) Patent Application Publication
(10) Pub. No.: US 2008/0257151 A1
(43) Pub. Date: Oct. 23, 2008

(54) WATER RETAINING DESSICATING DEVICE

(76) Inventor: Jonathan A. Mayer, Miami Beach, FL (US)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/104,782

(22) Filed: Apr. 17, 2008

Related U.S. Application Data
(60) Provisional application No. 60/912,180, filed on Apr. 17, 2007.

(51) Int. Cl. B01D 53/02; B01D 53/26; B65D 81/26

(52) U.S. Cl. 95/90; 206/204; 96/108; 96/118

(57) ABSTRACT

A desiccating device includes a rigid container having an end sealed by a selectively permeable membrane, operative to admit water vapor into the container, but not allow water to pass out of the container. A desiccant separates water from water vapor that has entered the container. A removable impermeable membrane seals the container, and prevents water vapor from entering the container when the impermeable membrane is in place. A reinforcing member having apertures is placed above the selectively permeable membrane, enabling a thinner and weaker selectively permeable membrane. The container shape defines angles of less than 90 degrees, as in a triangle or other truncated rectangle, where the device may be placed in a corner, projecting into the area to be dried less than a rectangular or circular container.

### CROSS-REFERENCE TO RELATED APPLICATION

This Application claims the benefit under 35 U.S.C. § 119(e) of U.S. Provisional Patent Application No. 60/912,180 (filed Apr. 17, 2007) and the contents of which are herein incorporated by reference in their entirety

### FIELD OF THE INVENTION

The invention relates to a system and method for dehumidifying a defined area, and in particular, to a dehumidifying packaging system incorporating a semi-permeable membrane and a dessicant, the system being storable, and activatable just prior to use.

### BACKGROUND OF THE INVENTION

Desiccant containers remove moisture from their surroundings, and may further be sealed or enclosed within a space or area so that eventually, a certain low level of ambient moisture may be attained within the space.

A problem is to ensure that the desiccant does not escape into the area, either rendering the container ineffective, or contaminating the area or matter within the area.

One solution disclosed in U.S. Pat. No. 5,114,003 to Jackisch et al. includes pressing or gluing the desiccant within the container. Another approach is disclosed in U.S. Pat. No. 5,148,613 to Cullen is to capture the desiccant between a perforated sheet and a container lid. Alternatively, the desiccant is retained within nettings, as disclosed in U.S. Pat. Nos. 6,344,072 to Gustafsson, or a fibrous fabric.

An alternative is to retain the desiccant behind a semi-permeable membrane, where the membrane allows water vapor to pass into an interior chamber containing the desiccant, but the desiccant and the liquid may not pass out, exterior to the chamber.

One such example is found in U.S. Pat. No. 5,743,942 to Shelley, where a pouch is formed from separate films, with one side being permeable to water vapor. Other examples of pouches may be found in U.S. Pat. Nos. 5,907,908 to Cunanan et al., and 5,773,105 to Klett. The pouches disclosed in these references are placed within containers, or are hung on a hanger.

While pouches may be useful in controlled conditions, they are inherently soft and vulnerable to puncture, and are thus better suited for use within a rigid container, or isolated on a hanger. This is also true for the container formed of semi-permeable material of U.S. Patent Publication 2005/0274259 to Young, et al.

The more rigid container disclosed in the aforemention patent to Cullen has an advantage of structural strength, and the ability to contain a relatively large amount of liquid safely, as compared with a pouch or other soft device.

However, Cullen requires that an elastic diaphragm contain the desiccant, and that the diaphragm be stretched under the cover prior to use. There remains a need, therefore, for a rigid container having a simpler mode of operation, and that avoids intentional or accidental contact with the desiccant.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 CFR § 1.56(a) exists.

### SUMMARY OF THE INVENTION

The present invention provides a dehumidifying packaging system which includes a desiccant disposed within a rigid container of plastic or other material that does not degrade in the presence of liquid, the liquid including water and water containing solubilized desiccant. The dehumidifying packaging system includes a container having an open end, where a desiccant is disposed within the container. The open end of the container is sealed with a semi-permeable or selectively permeable membrane which allows air or water vapor to enter the container, but does not allow solids or liquids to exit the container.

The selectively permeable membrane is adhered or heat bonded to an upper surface around the perimeter of the open end of the container, after the desiccant has been placed inside.

An additional layer, not significantly permeable or impermeable to gas and water vapor, is adhered, crimped, mechanically attached, or heat bonded to the container, as a layer above the selectively permeable membrane, operative to prevent water vapor from passing through to the selectively permeable membrane, and thereby maintaining the desiccant in a dry state, ready to absorb water.

In one embodiment in accordance with the invention, the impermeable membrane is replaceable, wherein the device may be configured to stop adsorbing or absorbing water until the impermeable membrane is once again removed. This enables the device to be transported or stored without further exposing the desiccant to moisture, and thus increasing the usable life of a product in accordance with the invention.

Additionally included is a reinforcing membrane or member more rigid than the selectively permeable membrane, provided with apertures through which water vapor may readily pass. The reinforcing membrane is placed over the selectively permeable membrane with respect to the interior of the container, and may be placed under or over the impermeable membrane. If placed over the impermeable membrane, it must be removable and replaceable, so that the impermeable membrane can be removed prior to use.

The reinforcing membrane provides support to the selectively permeable membrane, reducing the potential for rupture or tearing of the latter. This is particularly important for large container sizes, or to secure containment of large quantities of liquid and or desiccant.

In accordance with the invention, the desiccant is placed loosely within the container, and is retained therein by the selectively permeable membrane, as strengthened by the reinforcing membrane. As the desiccant is loose, it is capable of striking the selectively permeable membrane with significant force, as when the container is shaken. The reinforcing membrane thus prevents a breach or failure of the selectively permeable membrane.

As the container accumulates liquid, the desiccant will float to the liquid surface, forming an additional deterrent to spillage.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts an isometric view of the packaging system of the present invention;

FIG. 2 depicts a side sectional view of the packaging system of FIG. 1;

FIG. 3 depicts a perspective partial view of the membrane of the packaging system of FIG. 1;

FIG. 4 depicts a side view of the membrane of FIG. 3 showing a propagation of air and moisture there through;

FIG. 5 depicts a side view of the membrane of FIG. 3 showing a non-propagation of air and moisture there through;

FIG. 6 depicts the packaging system of FIG. 1 including a sealing element; and

FIG. 7 depicts an alternative embodiment of a packaging system in accordance with the invention.

### DETAILED DESCRIPTION OF THE INVENTION

In the description which follows, any reference to direction or orientation is intended primarily and solely for purposes of illustration and is not intended in any way as a limitation to the scope of the present invention. Also, the particular embodiments described herein are not to be considered as limiting of the present invention.

Referring now to the figures, in which like reference numerals refer to like elements, the present invention provides a dehumidifying packaging system which includes a desiccant disposed within a rigid container of plastic or other material that does not degrade in the presence of liquid, the liquid including water and water containing solubilized desiccant. The dehumidifying packaging system includes a container having an open end, where a desiccant is disposed within the container. The open end of the container is sealed with a semi-permeable or selectively permeable membrane which allows air or water vapor to enter the container, but does not allow solids or liquids to exit the container.

Average wall thickness for a container in accordance with the invention, operative to maintain a closet in a dry state, is 0.3 to 3.0 mm, although thickness may vary depending upon the overall size of the container, and the amount of liquid to be contained. Very large containers may have much greater thickness, and may be reinforced or fabricated with metal.

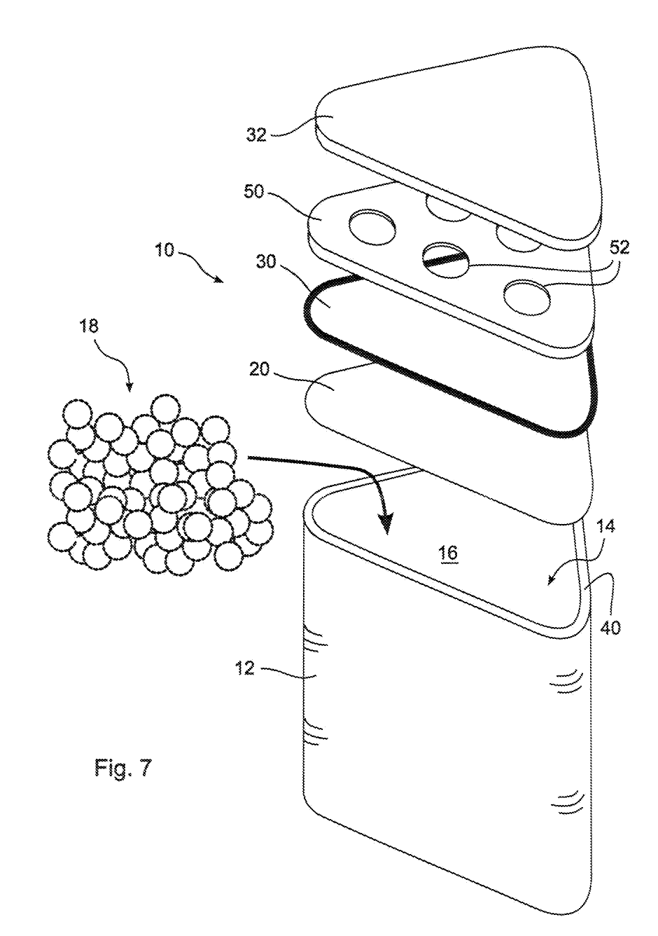

With reference to FIG. 7, it can be seen that container 12 is formed, in accordance with one embodiment of the invention, as a triangle or other shape defining one or more corner angles of less than 90 degrees, such as a truncated rectangle. In this manner, a device 10 may be placed within a corner of an area to be dried, projecting into the area less than, say, a rectangular or circular shaped object. In this manner, the device 10 is less obtrusive, and is less likely to be accidentally or intentionally disturbed.

The desiccant material can be a deliquescent material used to remove moisture from air, where the deliquescent material forms an aqueous solution when exposed to moisture, which is collected in a container. Such deliquescent material includes calcium chloride, which forms an aqueous solution as it reacts with moisture, removing the moisture from the air.

The desiccant material can be a water-swellable polymer, also referred to as absorbent gelling material, AGM, or super-absorbent polymers, or SAP's. These polymer materials ensure that moisture can be removed from the air, and locked away in the packaging material. Especially useful water-swellable polymers or SAP's are often made by initially polymerizing unsaturated carboxylic acids or derivatives thereof, such as acrylic acid, alkali metal (e.g., sodium and/or potassium) or ammonium salts of acrylic acid, alkyl acrylates, and the like in the presence of relatively small amounts of di- or poly-functional monomers such as N,N′-methylenebisacrylamide, trimethylolpropane triacrylate, ethylene glycol di(meth)acrylate, or triallylamine.

Alternatively, the desiccant material can be a silica gel. Silica gel is a granular, porous form of silica made synthetically from sodium silicate. Despite the name, silica gel is a solid. It is usually distributed in the form of beads.

Silica gel's high surface area (around 800 m²/g) allows it to adsorb water readily, making it useful as a desiccant (drying agent). It can reduce the relative humidity in a closed space to around 40%. Once saturated with water, the gel can be regenerated by heating to 150° C. (300° F.) for 1.5 hours per liter of gel. Some types of silica gel will “pop” when exposed to sufficient amounts of water.

Additional desiccants that may be used in accordance with the invention include a wide variety of hygroscopic materials, including calcium sulfate, montmorillonite clay, and molecular sieves.

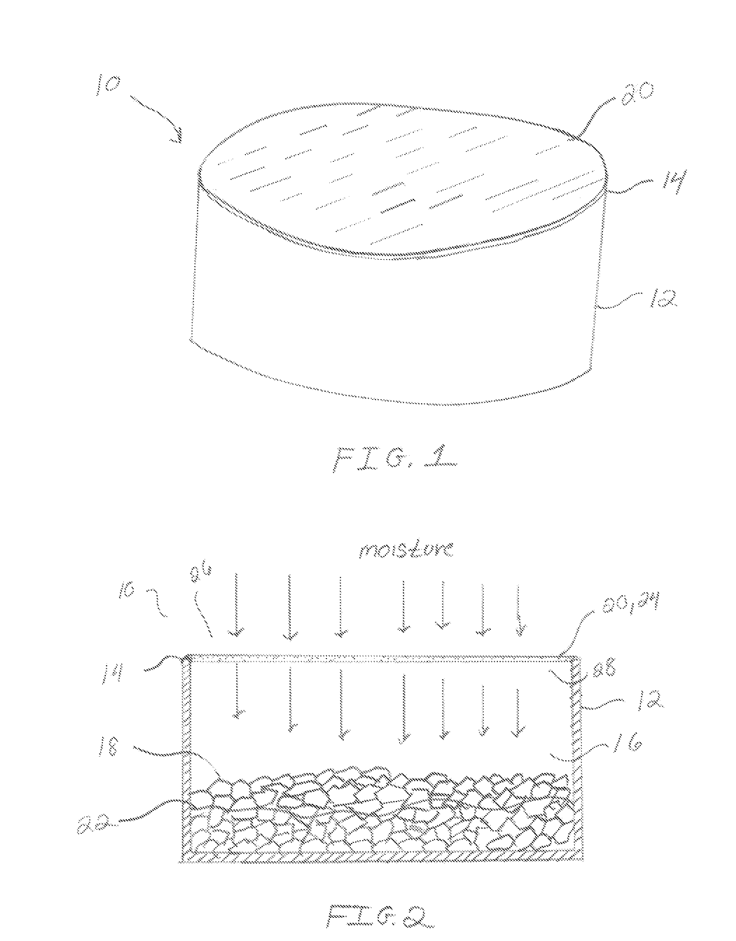

FIGS. 1 and 2 illustrate a packaging system 10 in accordance with the present invention. The packaging system 10 includes container 12 having an open end 14 and an interior space 16. A desiccant material 18 is positioned in the interior space 16 of the container 12.

A permeable membrane 20 is positioned and affixed over the open end 14 of the container 12, sealing the desiccant material 18 within the interior space 16 of the container 10. The permeable membrane 20 permits the propagation of air and moisture through the permeable membrane 20, such that the desiccant material 18 reacts to remove moisture from the air.

In the instance where the desiccant material 18 is a water-swellable polymer, the desiccant material 18 swells upon absorption of the moisture, trapping the moisture within the interior space 16 of the container 10.

In the instance were the desiccant material 18 is a deliquescent material which forms an aqueous solution when exposed to moisture, such as calcium chloride, an aqueous solution 22 is formed within the interior space 16 of the container 10.

The permeable material 20 can be a permeable flexible polymeric or plastic material. For example, permeable material 20 can be made of polyethylene, polyethylene terephthalate, oriented polypropylene, and the like. Alternatively, the permeable material 20 can be made of permeable fabric, paper, cellulose, or fibrous materials.

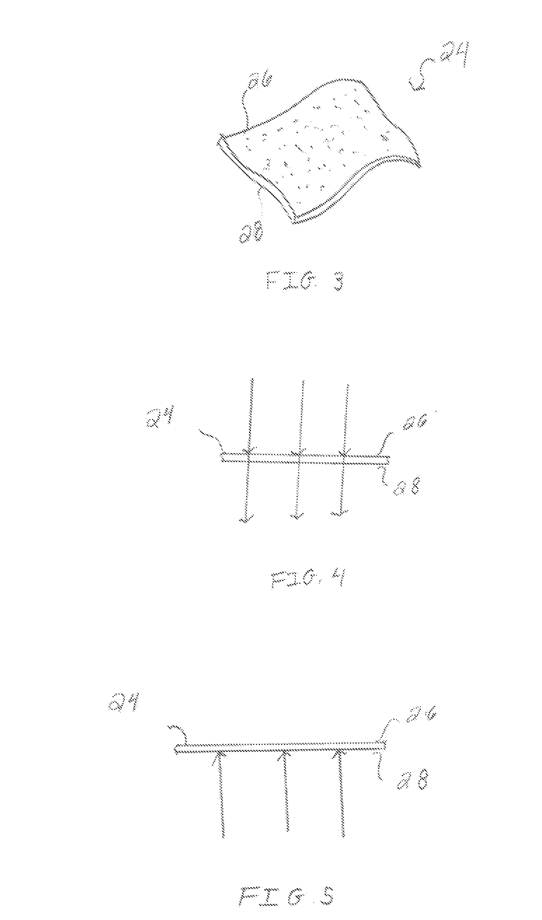

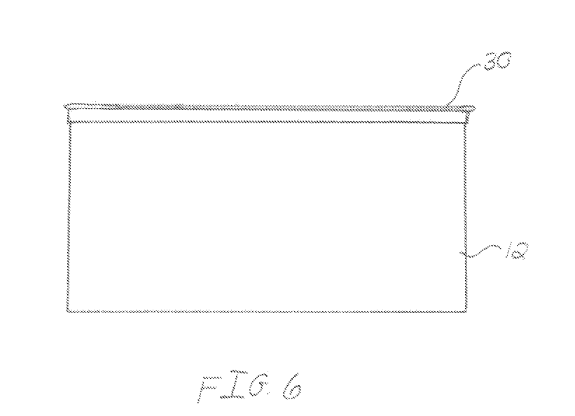

Referring to FIG. 3, the permeable membrane may also be a one way permeable membrane 24. The one-way permeable membrane 24 includes a first side 26 and a second side 28. As shown in FIG. 4, the first side 26 of the one-way permeable membrane 24 permits the propagation of air and moisture through the one-way permeable membrane 24. As shown in FIG. 5, the second side 28 of the one-way permeable membrane 24 prevents the propagation of moisture through the one-way permeable membrane, such that the moisture remains trapped on the second side 28 of the one-way permeable membrane 24. Alternatively, permeable membrane 20,24 may be a single sheet of material having the properties, for example, of Tyvec, a trademark of Dupont of Delaware for a high-density polyethylene fiber, or Gore-Tex, a trademark of W.L. Gore & Associates, also of Delaware, for a microporous polytetrafluoroethylene fabric.

In this manner, as can also be seen in FIG. 2, air and moisture can propagate from the first side 26 of the one-way permeable membrane 24, through the one-way permeable membrane 24 into the interior space 16 of the container 12. The propagated moisture reacts with the desiccant material 18 within the interior space 16 of the container 12 such that the moisture is removed from the air.

The second side 28 of the one-way permeable membrane 24 acts a barrier, preventing the propagation of moisture from within the interior space 16 of the container 12 through the one-way permeable membrane 24, thus trapping the moisture within the interior space 16 of the container 12.

The one-way permeable material 24 can be a permeable flexible polymeric or plastic material. For example, the one-way permeable material 24 can be made of polyethylene, polyethylene terephthalate, oriented polypropylene, and the like. Alternatively, the one-way permeable material 24 can be made of permeable fabric, paper, cellulose, or fibrous materials.

The container 12 can be made of impermeable flexible polymeric or plastic materials. For example, the container 12 can be made of polyethylene, polyethylene terephthalate, oriented polypropylene, and the like. The impermeable container 12 substantially preventing the propagation of air through the container 12 into the inner space 16, or the propagation of moisture from the inner 16 to outside the container 12.

Referring to FIG. 6, the container 12 further includes a sealing element 30 positioned over the open end 14 of the container 12 The sealing element 30 is made of an impermeable material, such that air and moisture cannot propagate into the interior space 16 of the container 12.

In an embodiment, the sealing element 30 is made of impermeable flexible polymeric or plastic materials. For example, the sealing element 30 can be made of polyethylene, polyethylene terephthalate, oriented polypropylene, and the like. The sealing element 30 substantially prevents the propagation of air and moisture into the interior space 16 of the container 12, increasing the storage life of the desiccant 18. In use, the sealing element 30 is removed or punctured, allowing for the propagation of air and moisture into the interior space 16 of the container 12.

The sealing element 30 can be a lip or cap snuggly positioned over the open end 14 of the container 12, the preventing the propagation of moisture into the inner space 16 of the container. Alternatively, the sealing element 30 can be a non-permeable film positioned over the open end 14 of the container 12, where the non-permeable film including an adhesive for securing the non-permeable film to the permeable membrane 20, 24, sealing the open end 14 of the container 12.

In the above embodiments, the packaging system 10 is provided to the consumer in a sealed condition, such that the absorption of moisture by of the desiccant 18 is retarded or substantially prevented, increasing the shelf life of the packaging systems 10. It is also contemplated that the packaging system 10 sealing element 30 can be resealed over the open end 14 of the container 12, preventing the further propagation of moisture into the inner space 16 of the container 12.

To further increase the “shelf life” of the packaging system 10, the packaging system 10 can be shrink wrapped with a non-permeable material.

With reference now to FIG. 7, selectively permeable membrane 20 is adhered or heat bonded to an upper surface 40 around the perimeter of open end 14 of container 12, after desiccant 18 has been placed inside 16.

An additional layer 30, not significantly permeable, or impermeable to gas and water vapor, is adhered, crimped, mechanically fastened, or heat bonded to the container, as a layer above selectively permeable membrane 20. Layer 30 is operative to prevent water vapor from passing through to selectively permeable membrane 20, and thereby maintaining the desiccant in a dry state, ready to absorb water. Mechanical fastening may include a deformable interlocking perimeter, as is commonly found in plastic food storage containers. Heat bonding may include the melting of adhesive on either the surface of the perimeter of the container, a subtending layer, or the perimeter of layer 30. Alternatively, the heat may melt either a portion of layer 30, or a portion of the container, or a subtending layer, such as the selectively permeable layer positioned beneath layer 30. Any combination of the above may be adhered or melted to seal the impermeable layer to the container, whereby water vapor may not pass to the interior of the container until layer 30 is removed.

In one embodiment in accordance with the invention, impermeable membrane 30 is replaceable, wherein the device may be configured to stop adsorbing or absorbing water (depending on the mode of action of the desiccant) until impermeable membrane 30 is once again removed. This enables the device to be transported or stored without further exposing the desiccant to moisture, and thus increasing the usable life of a product in accordance with the invention.

In a further embodiment, impermeable membrane 32 is provided, in the form of a cover, having a snap sealing flange or other mechanical fastener operative to sealingly engage open end 14, adjacent or in connection to upper surface 40. Impermeable membrane 32 may be provided instead of impermeable membrane 30, or in addition to the latter. The mechanical fastener may be a deformable interlocking perimeter, as may be found in plastic food storage containers.

Additionally included is reinforcing membrane 50, which is more rigid and durable than selectively permeable membrane 20, and is provided with apertures 52 through which water vapor may readily pass. Reinforcing membrane 50 is placed over selectively permeable membrane 20 with respect to the interior 16 of container 12, and may be placed under or over impermeable membrane 30. If placed over impermeable membrane 30, it must be removable and replaceable, so that impermeable membrane 30 can be removed prior to use.

Reinforcing member 50 provides support to selectively permeable membrane 20, reducing the potential for rupture or tearing of the latter. This is particularly important for large container 12 sizes, or to secure containment of large quantities of liquid 22 and or desiccant 18. Reinforcing member 50 may advantageously be formed of plastic of a thickness similar to that of the container. Reinforcing member 50 may be provided with a deformable interlocking perimeter, so that reinforcing membrane 50 may be removed and replaced, for example to remove or replace impermeable membrane 30.

In accordance with the invention, desiccant 18 is placed loosely within container 18, and is retained therein by selectively permeable membrane 20, as strengthened by reinforcing membrane 50. As desiccant 18 is loose, it is capable of striking selectively permeable membrane 20 with significant force, as when container 12 is shaken. Reinforcing membrane 30 thus prevents a breach or failure of selectively permeable membrane 20.

Desiccant 18 may be selected to clump together when moist, as when separating water from water vapor. As it clumps, it may also be selected to swell, and to float above water 22. In this manner, the clumped desiccant 18 forms a seal against the inner side surfaces of container 12. As container 12 accumulates liquid 22, desiccant 18 will float to the liquid 22 surface, swelling and forming a seal, thus further serving to deter spillage. In this manner, sloshing during transport is greatly reduced, and the possibility of spillage is further reduced. FIG. 2 illustrates desiccant 18 prior to rising above water 22.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. A device for drying air within an area in which the device is placed, comprising:
a desiccant operative to separate water from water vapor in the air;
a liquid impermeable container operative to contain said desiccant, and a quantity of water separated by said desiccant, said container defining an interior and further including
an open end defining a perimeter;
a closed end; and
a flange formed around said perimeter of said open end;
a selectively permeable membrane sealingly connected to said flange to seal said open end of said container, said selectively permeable membrane operative to admit the passage of water vapor from outside said container to inside said container, and to prevent the passage of water from inside said container to outside said container;
an impermeable sealing membrane releasably and sealingly connected to said container and operative to prevent the passage of water vapor from outside said container to inside said container; and
a reinforcing member connectable to said container and operative to permit the passage of water vapor from outside the container to inside the container, and further operative to provide mechanical support to said selectively permeable membrane;
wherein said impermeable sealing member is removed when the device is intended to be used, whereby said desiccant may then begin to separate water from water vapor.

2. The device of claim 1, further including a cover operative to sealingly engage said container and prevent the passage of water vapor from outside the container to inside the container.

3. The device of claim 1, wherein said container is plastic, and has an average thickness of 0.3 to 3 mm.

4. The device of claim 1, wherein the desiccant is a deliquescent material.

5. The device of claim 1, wherein the desiccant is selected from the group consisting of: water swellable polymer, absorbent gelling material, super-absorbent polymer, silica gel, calcium chloride.

6. The device of claim 1, wherein the desiccant is selected from the group consisting of: hygroscopic material, calcium sulfate, montmorillonite clay, molecular sieve.

7. The device of claim 1, wherein the selectively permeable membrane is fabricated with a material selected from the group consisting of: flexible polymer material, polyethylene, polyethylene terephthalate, oriented polypropylene, fabric, paper, cellulose, fibrous materials.

8. The device of claim 1, wherein the selectively permeable membrane is fabricated with a material selected from the group consisting of: Tyvec, a trademark of Dupont of Delaware for a high-density polyethylene fiber, and Gore-Tex, a trademark of W.L. Gore & Associates, also of Delaware, for a microporous polytetrafluoroethylene fabric.

9. The device of claim 1, further including a wrapping of plastic completely enveloping and sealing the device, said wrapping operative to further retard passage of water vapor into the container, until, at least, said wrapping is removed.

10. The device of claim 1, wherein said impermeable membrane is releasably connected to the container by means selected from the group consisting of: glue, crimp, mechanical fastener, deformable interlocking perimeter, heat bonding, bonding by melting.

11. The device of claim 1, wherein said impermeable membrane is replaced to substantially retard or stop the continued passage of water vapor to the interior of the container.

12. The device of claim 1, wherein said reinforcing member has an average thickness of 0.3 to 3 mm.

13. The device of claim 1, wherein said desiccant is selected to clump together and swell when separating water from water vapor.

14. The device of claim 13, wherein said clumped and swollen desiccant forms a seal against an interior surface of the container, and floats upon the surface of separated liquid, thereby preventing passage of separated liquid to said selectively permeable membrane.

15. The device of claim 1, wherein said container has an outer dimension defining at least two corners, each of said corners forming an angle of less than ninety degrees.

16. The device of claim 1, wherein said selectively permeable membrane is adhered to said container, and said impermeable membrane is adhered to said selectively permeable membrane, wherein said impermeable membrane is removable without disturbing a seal between said impermeable membrane and said container.

17. The device of claim 16, wherein said reinforcing member is attached to said container with a deformable interlocking perimeter.

18. The device of claim 2, wherein said cover is provided with a deformable interlocking perimeter, and wherein said reinforcing member is provided with a deformable interlocking perimeter, whereby said reinforcing member may be removed, and said cover attached, when it is desired to stop water vapor from entering the container.

19. A device for drying air within an area in which the device is placed, the device comprising:
a desiccant operative to separate water from water vapor in the air;
a liquid impermeable container operative to contain said desiccant and a quantity of water separated by said desiccant, having an outer dimension defining at least one corner forming an angle of less than 90 degrees, said container defining an interior, and further including
an open end defining a perimeter;
a closed end; and
a flange formed around said perimeter of said open end;
a selectively permeable membrane sealingly connected to said flange to seal said open end of said container, said selectively permeable membrane operative to admit the passage of water vapor from outside said container to inside said container, and to prevent the passage of water from inside said container to outside said container;
an impermeable sealing membrane releasably and sealingly connected to said container and operative to prevent the passage of water vapor from outside said container to inside said container; and
a reinforcing member connectable to said container and operative to permit the passage of water vapor from outside the container to inside the container, and further operative to provide mechanical support to said selectively permeable membrane;
wherein said at least one corner angle enables the placement of said device proximate a corner of the area, reducing the amount to which the device projects from the corner; and
wherein said impermeable sealing member is removed when the device is intended to be used, whereby said desiccant may thereafter begin to separate water from water vapor.

20. A method for drying air within an area, comprising the steps of:
providing a desiccant operative to separate water from water vapor in the air;
placing the dessicant within a liquid impermeable container operative to contain the desiccant and a quantity of water separated by the desiccant, the container defining an interior, and further including
an open end defining a perimeter;
a closed end; and
a flange formed around said perimeter of the open end;
attaching a selectively permeable membrane to sealingly connect to the flange to seal the open end of the container, the selectively permeable membrane operative to admit the passage of water vapor from outside the container to inside the container, and to prevent the passage of water from inside the container to outside the container;
releasably attaching an impermeable sealing membrane to sealingly connect to the container and operative to prevent the passage of water vapor from outside the container to inside the container; and
installing a reinforcing member onto the container, operative to permit the passage of water vapor from outside the container to inside the container, and further operative to provide mechanical support to the selectively permeable membrane;
wherein the impermeable sealing member is removed when the device is intended to be used, whereby the desiccant may then begin to separate water from water vapor.
